(19) United States
(12) Patent Application Publication
(10) Pub. No.: US 2013/0111318 A1
(43) Pub. Date: May 2, 2013

(54) COMMUNICATION TERMINAL APPARATUS

(71) Applicants: Hiroshi FUJINO, Fuchu (JP); Katsuaki AKAMA, Yokohama (JP)

(72) Inventors: Hiroshi FUJINO, Fuchu (JP); Katsuaki AKAMA, Yokohama (JP)

(73) Assignee: FUJITSU LIMITED, Kawasaki-shi (JP)

(21) Appl. No.: 13/605,839

(22) Filed: Sep. 6, 2012

(30) Foreign Application Priority Data
Oct. 28, 2011 (JP) 2011-238026

(51) Int. Cl. G06F 17/00

(52) U.S. Cl. 715/205

(57) ABSTRACT

A communication terminal apparatus includes a storage unit and a processor. The storage unit stores an obtained file and identification information in association with each other. The identification information identifies a source of the obtained file. The processor displays, in a display unit, a screen including a link character string associated with the identification information. The processor displays in the display unit, when a plurality of target files exist in the storage unit, options used to select one of the plurality of target files. Each of the plurality of target files is associated with the identification information which is associated with the link character string included in the screen.

### CROSS-REFERENCE TO RELATED APPLICATION

This application is based upon and claims the benefit of priority of the prior Japanese Patent Application No. 2011-238026, filed on Oct. 28, 2011, the entire contents of which are incorporated herein by reference.

### FIELD

The embodiments discussed herein are related to a communication terminal apparatus.

### BACKGROUND

Programs for obtaining hypertext data from a server and displaying the hypertext data in a screen have been broadly used. Such a program is referred to as a “browser”. A technique relating to such a browser has been proposed, in which obtained hypertext data is temporarily stored in a cache memory. When hypertext data corresponding to a link destination specified by a user exists in the cache memory, the hypertext data to be displayed is not obtained from the server again but is obtained from the cache memory.

Japanese Laid-open Patent Publication No. 2002-304413 discloses a related technology.

However, in traditional hypertext display apparatuses, even if hypertext data corresponding to a link destination specified by a user has been downloaded a number of times, only the latest downloaded hypertext data is stored in a cache memory. Therefore, there arises a problem in that the hypertext data downloaded before the latest hypertext data is not displayed.

### SUMMARY

According to an aspect of the present invention, provided is a communication terminal apparatus including a storage unit and a processor. The storage unit stores an obtained file and identification information in association with each other. The identification information identifies a source of the obtained file. The processor displays, in a display unit, a screen including a link character string associated with the identification information. The processor displays in the display unit, when a plurality of target files exist in the storage unit, options used to select one of the plurality of target files. Each of the plurality of target files is associated with the identification information which is associated with the link character string included in the screen.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a communication terminal apparatus according to a first embodiment;

FIG. 2 is a block diagram illustrating a hardware configuration of a communication terminal apparatus according to a second embodiment;

FIG. 3 is a block diagram illustrating a functional configuration of the communication terminal apparatus according to the second embodiment;

FIG. 4 is a diagram schematically illustrating a cache function of the communication terminal apparatus according to the second embodiment;

FIG. 5 is a diagram schematically illustrating the cache function of the communication terminal apparatus according to the second embodiment;

FIG. 6 is a flowchart illustrating a cache history process performed by the communication terminal apparatus according to the second embodiment;

FIG. 7 is a flowchart illustrating a cache display process performed by the communication terminal apparatus according to the second embodiment;

FIG. 8 is a flowchart illustrating a cache URL retrieving process performed by the communication terminal apparatus according to the second embodiment;

FIG. 9 is a flowchart illustrating a cache record display process performed by the communication terminal apparatus according to the second embodiment;

FIG. 10 is a block diagram illustrating a hardware configuration of a communication terminal apparatus according to a third embodiment;

FIG. 11 is a block diagram illustrating a functional configuration of the communication terminal apparatus according to the third embodiment;

FIG. 12 is a diagram schematically illustrating a screen memo function of the communication terminal apparatus according to the third embodiment;

FIG. 13 is a diagram schematically illustrating the screen memo function of the communication terminal apparatus according to the third embodiment;

FIG. 14 is a flowchart illustrating a screen memo history process performed by the communication terminal apparatus according to the third embodiment;

FIG. 15 is a flowchart illustrating a screen memo display process performed by the communication terminal apparatus according to the third embodiment;

FIG. 16 is a flowchart illustrating a screen memo URL retrieving process performed by the communication terminal apparatus according to the third embodiment; and

FIG. 17 is a flowchart illustrating a screen memo record display process performed by the communication terminal apparatus according to the third embodiment.

### DESCRIPTION OF EMBODIMENTS

Embodiments of a communication terminal apparatus will be described with reference to the accompanying drawings. In the embodiments below, the same components are denoted by the same reference numerals and redundant descriptions are omitted.

### First Embodiment

### Communication Terminal Apparatus

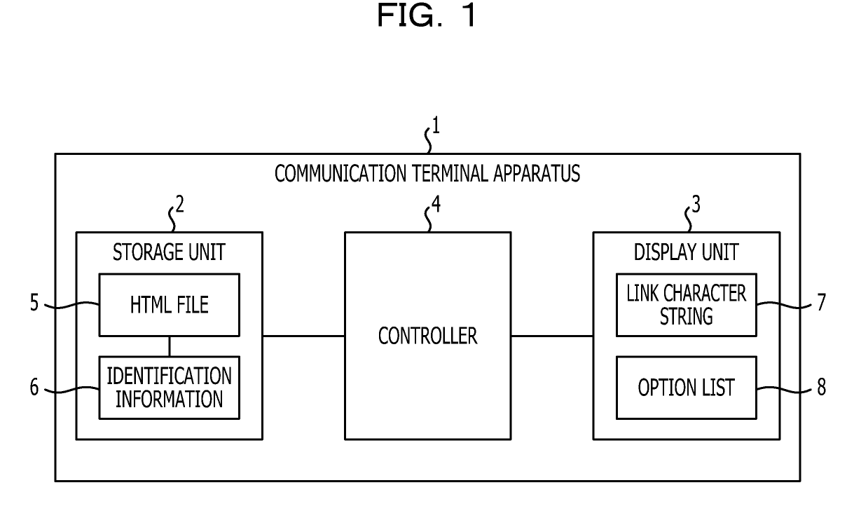

FIG. 1 is a block diagram illustrating a communication terminal apparatus according to a first embodiment. As illustrated in FIG. 1, a communication terminal apparatus 1 includes a storage unit 2, a display unit 3, and a controller 4.

The storage unit 2 stores an obtained hypertext markup language (HTML) file 5 and identification information 6 which identifies a source of the HTML file 5 in a state in which the HTML file 5 is associated with the identification information 6.

The controller 4 displays a screen including a link character string 7 associated with the identification information 6 in the display unit 3. When a plurality of target HTML files exist in the storage unit 2, the controller 4 displays, in the display unit 3, an option list 8 used to select one of the target HTML files. A target HTML file is an HTML file 5 corresponding to the identification information 6 associated with the link character string 7 included in the screen.

The display unit 3 displays the screen including the link character string 7 associated with the identification information 6. The display unit 3 displays the option list 8 used to select one of the target HTML files.

According to the first embodiment, when a plurality of target HTML files which are obtained from the same source exist in the storage unit 2, the option list 8 is displayed in the display unit 3. Accordingly, the user may select an arbitrary one of the target HTML files from the option list 8 so that the selected target HTML file is displayed in the display unit 3.

### Second Embodiment

Examples of a communication terminal apparatus include a cellular phone, a smart phone, and a personal computer. Examples of identification information include a URI (Uniform Resource Identifier) such as URL (Uniform Resource Locator) information and URN (Uniform Resource Name) information. In a second embodiment, a case where a communication terminal apparatus corresponds to an electronic computer such as a personal computer and a URL is used as identification information will be described as an example. A browser function executed in electronic computers such as personal computers provide a cache function of storing, in a storage unit, screens displayed in a display unit 3.

Hardware Configuration of Communication Terminal Apparatus

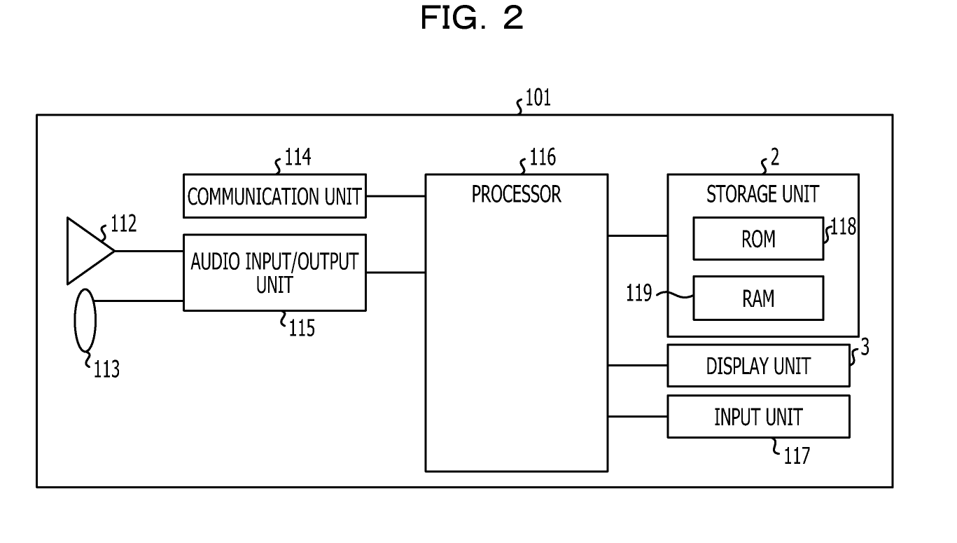

FIG. 2 is a block diagram illustrating a hardware configuration of the communication terminal apparatus according to the second embodiment. As illustrated in FIG. 2, a communication terminal apparatus 101 includes a speaker 112, a microphone 113, a communication unit 114, an audio input/output unit 115, a processor 116, a storage unit 2, a display unit 3, and an input unit 117. The processor 116 is an example of a controller.

The processor 116 executes a cache recording process, a cache history process, a cache display process, a cache URL retrieving process, and a cache record display process. The processor 116 executes a browser function. The cache history process, the cache display process, the cache URL retrieving process, and the cache record display process will be described later.

The communication unit 114 is connected to the processor 116 and further connected to a network such as a public line, the Internet, a LAN (local area network), or WAN (wide area network) which is omitted in FIG. 2. The storage unit 2 is connected to the processor 116 and includes a ROM (read-only memory) 118 and a RAM (random access memory) 119. The ROM 118 is merely an example of a memory and is replaceable by a rewritable nonvolatile memory such as a flash memory.

The storage unit 2 stores programs for causing the processor 116 to execute the cache history process, the cache display process, the cache URL retrieving process, the cache record display process, and the browser function. The storage unit 2 stores the HTML file 5 described in the first embodiment, for example. The storage unit 2 further stores URL information, for example, as an example of the identification information 6. The RAM 119 is used as a work area of the processor 116.

Note that it is not necessarily the case that these programs are stored in the storage unit 2 but these programs may be stored in a recording medium such as a CD-ROM (compact disc read-only memory) and read and executed by the communication terminal apparatus 101. Furthermore, these programs may be stored in another computer (or a server) or the like connected to the communication terminal apparatus 101 through a public line, the Internet, a LAN, a WAN, or the like. In this case, the communication terminal apparatus 101 reads the programs from the computer or the like to execute the programs.

The speaker 112 and the microphone 113 are connected to the audio input/output unit 115. The audio input/output unit 115 is connected to the processor 116 and performs processes associated with output and input of audio. The display unit 3 is connected to the processor 116 and displays results of processes performed by the processor 116. The input unit 117 is connected to the processor 116 and accepts a key input and an input using a pointing device such as a mouse performed by a user.

Functional Configuration of Communication Terminal Apparatus

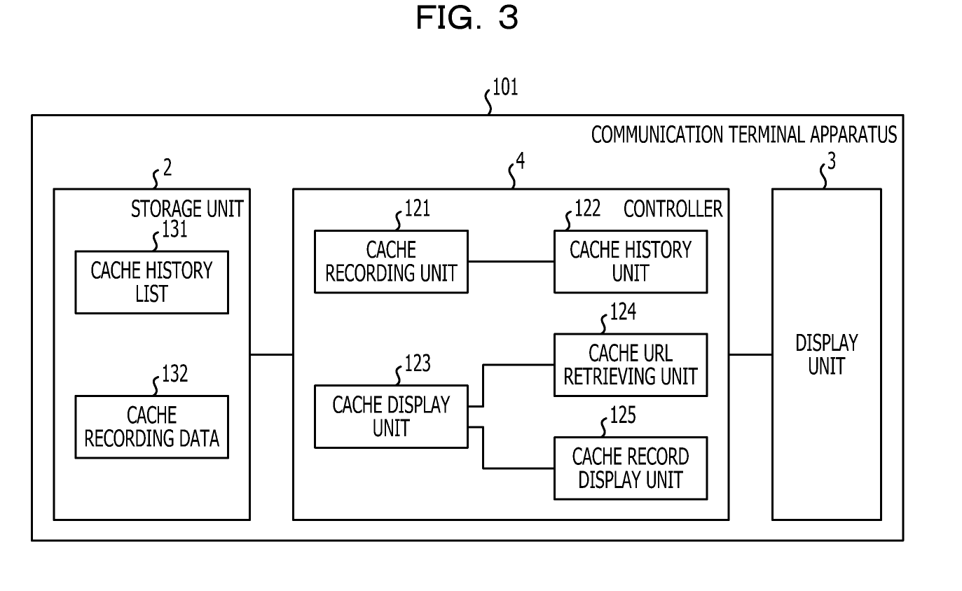

FIG. 3 is a block diagram illustrating a functional configuration of the communication terminal apparatus according to the second embodiment. As illustrated in FIG. 3, a controller 4 of the communication terminal apparatus 101 realizes a cache recording unit 121, a cache history unit 122, a cache display unit 123, a cache URL retrieving unit 124, and a cache record display unit 125 by executing various programs stored in the storage unit 2.

The cache recording unit 121 executes the cache recording process. By executing the cache recording process, HTML data downloaded by the browser function is recorded in the storage unit 2. The cache history unit 122 is called by the cache recording unit 121 to execute the cache history process which will be described later. As a result of the execution of the cache history process, a cache history list 131 and cache recording data 132, which is an example of the HTML file 5, are stored in the storage unit 2.

The cache display unit 123 executes the cache display process which will be described later. The cache URL retrieving unit 124 is called by the cache display unit 123 to execute the cache URL retrieving process which will be described later. The cache record display unit 125 is called by the cache display unit 123 to execute the cache record display process which will be described later.

Cache Function

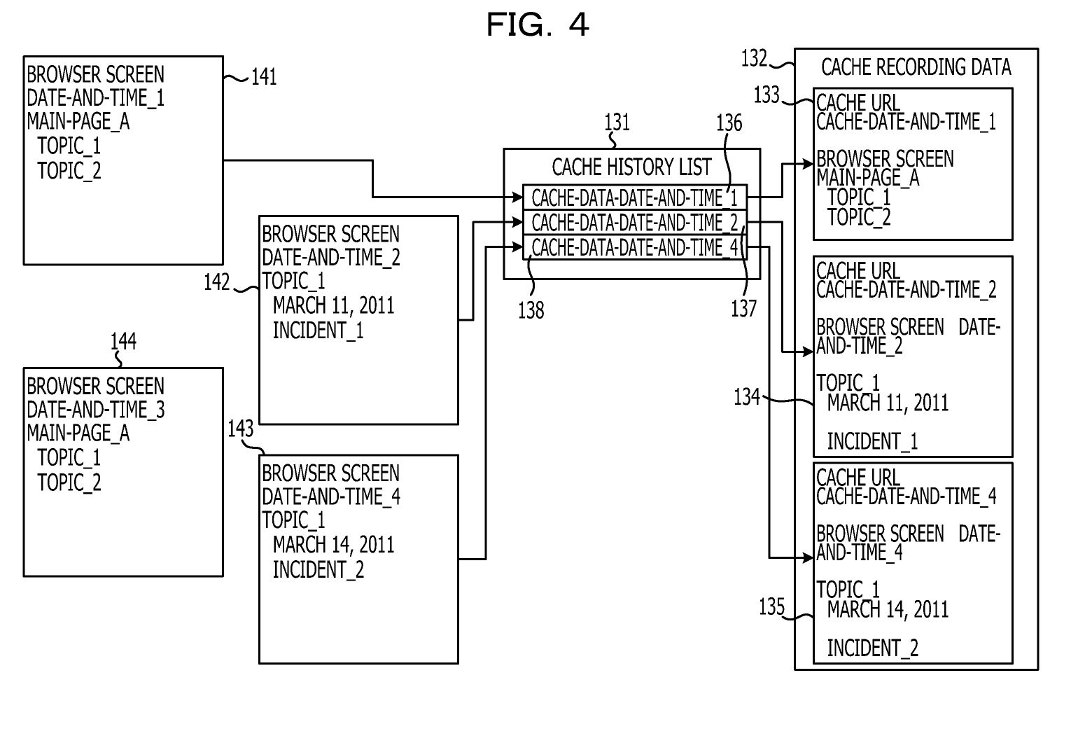

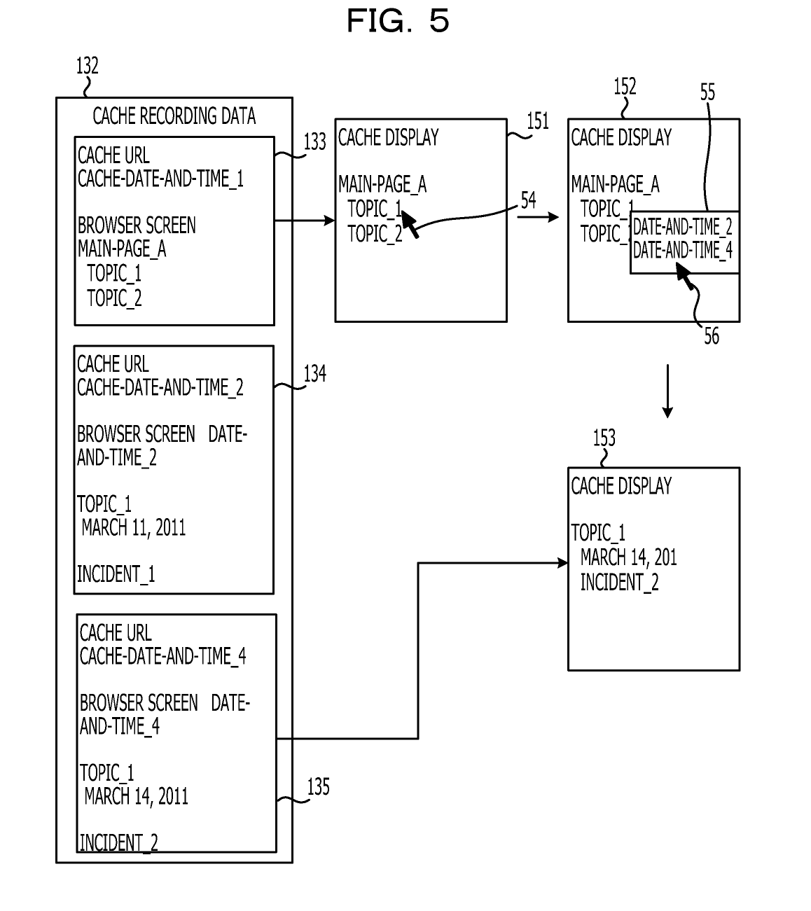

FIGS. 4 and 5 are diagrams schematically illustrating cache functions of the communication terminal apparatus 101 according to the second embodiment. FIG. 4 illustrates a function, among the cache functions, of recording a browser screen as cache data. The function of recording a browser screen is realized by the cache recording unit 121 and the cache history unit 122 of the controller 4.

As illustrated in FIG. 4, in the communication terminal apparatus 101, browser screens 141 to 144 are displayed in the display unit 3. For example, in the browser screen 141, “Browser Screen” represents that a browser screen is being displayed. “Date-and-Time_{—}1” represents that a display date and time is displayed. “Main-Page_A” represents that a main page_A is displayed. “Topic_{—}1” is a link character string and represents that a link to a topic_{—}1 is provided. “Topic_{—}2” is a link character string and represents that a link to a topic_{—}2 is provided.

For example, in the browser screen 142, “Browser Screen” represents that a browser screen is being displayed. “Date-and-Time_{—}2 . . . ” represents that a display date and time is displayed. “Topic_{—}1” represents that the topic_{—}1 is displayed. “Mar. 11, 2011” and “Incident_{—}1” represent that an incident_{—}1 updated in Mar. 11, 2011 is displayed as content of the topic_{—}1.

For example, in the browser screen 143, “Browser Screen” represents that a browser screen is being displayed. “Date-and-Time_{—}4” represents that a display date and time is displayed. “Topic_{—}1” represents that the topic_{—}1 is displayed. “Mar. 14, 2011” and “Incident_{—}2” represent that an incident_{—}2 updated in Mar. 14, 2011 is displayed as content of the topic_{—}1.

For example, in the browser screen 144, “Browser Screen” represents that a browser screen is being displayed. “Date-and-Time_{—}3” represents that a display date and time is displayed. “Main-Page_A” represents that a main page_A is displayed. “Topic_{—}1” is a link character string and represents that a link to a topic_{—}1. “Topic_{—}2” is a link character string and represents that a link to a topic_{—}2 is provided.

The date and time representing update of the content in the screen of “Topic_{—}1” displayed in the browser screen 142 and the date and time representing update of the content in the screen of “Topic_{—}1” displayed in the browser screen 143 are different from each other. Accordingly, as illustrated in FIG. 4, content of the topic_{—}1 corresponding to “Date-and-Time_{—}2” may be “Incident_{—}1” and content of the topic_{—}1 corresponding to “Date-and-Time_{—}4” may be “Incident_{—}2”, which are different from each other.

For example, when the browser function downloads HTML data to be displayed in a browser screen from a web server through the Internet or the like, the downloaded HTML data is stored in cache recording data 132. Although not particularly limited, it is assumed that HTML data of the content displayed in the browser screens 141 to 143 is recorded in the cache recording data 132 in this embodiment.

The HTML data of the content is stored as an individual HTML file 133, 134, or 135 in association with URL information (cache URL), for example, of the HTML data and date and time information (cache date and time) of the HTML data downloaded and recorded in the cache recording data 132 by the browser function. For example, in the HTML file 133 corresponding to the browser screen 141, HTML data of “Cache URL” and HTML data of “Cache-Date-and-Time_{—}1” which correspond to the browser screen 141, HTML data representing “Browser Screen”, HTML data representing “Main-Page_A”, HTML data representing a link character string “Topic_{—}1”, and HTML data representing a link character string “Topic_{—}2” may be recorded in the cache recording data 132.

For example, in the HTML file 134 corresponding to the browser screen 142, HTML data of “Cache URL” and HTML data of “Cache-Date-and-Time_{—}2” which correspond to the browser screen 142, HTML data representing “Date-and-Time_{—}2”, and HTML data representing “Browser Screen”, HTML data representing “Topic_{—}1”, and HTML data representing “Incident_{—}1” updated in “Mar. 11, 2011” may be recorded in the cache recording data 132. For example, in the HTML file 135 corresponding to the browser screen 143, HTML data of “Cache URL” and HTML data of “Cache-Date-and-Time_{—}4” which correspond to the browser screen 143, HTML data representing “Date-and-Time_{—}4”, HTML data representing “Browser Screen”, HTML data representing “Topic_{—}1”, and HTML data representing “Incident_{—}2” updated in “Mar. 14, 2011” may be recorded in the cache recording data 132.

Furthermore, beginning addresses 136 to 138 of the HTML files 133 to 135 recorded in the cache recording data 132 are added to the cache history list 131. In the cache history list 131, “Cache-Data-Date-and-Time_{—}1” represents that the beginning address of the HTML file 133 corresponding to the browser screen 141 displayed at a time point of “Date-and-Time_{—}1” is stored in the cache history list 131. “Cache-Data-Date-and-Time_{—}2” and “Cache-Data-Date-and-Time_{—}4” represent similar things.

FIG. 5 illustrates a function, among the cache functions, of displaying cache data. The function of displaying cache data is realized by the cache display unit 123, the cache URL retrieving unit 124, and the cache record display unit 125 of the controller 4. It is assumed that the HTML files 133 to 135 are recorded in the cache recording data 132 in advance by being downloaded by the browser function.

It is further assumed that, as illustrated in FIG. 5, a browser screen 151 is displayed in the display unit 3 of the communication terminal apparatus 101 and a screen of “Main-Page_A” is displayed in the browser screen 151 using the cache function in accordance with a user's instruction. “Cache Display” represents that cache data is being displayed. In this case, link character strings “Topic_{—}1” and “Topic_{—}2” may be displayed in the browser screen 151. Thereafter, when the user causes a cursor 54 displayed in the browser screen 151 to move onto the link character string “Topic_{—}1”, an option window 55 used to select one of the HTML file 134 corresponding to “Date-and-Time_{—}2” and the HTML file 135 corresponding to “Date-and-Time_{—}4” is displayed in a browser screen 152.

In the option window 55, “Date-and-Time_{—}2” and “Date-and-Time_{—}4” representing date and times at which the HTML files are recorded in the cache recording data 132 may be displayed as link character strings. The option window 55 may be displayed close to the link character string “Topic_{—}1”, for example. When a corresponding HTML file is recorded in the cache recording data 132 as in the case of “Topic_{—}1”, the link character string “Topic_{—}1” may be displayed in a certain color, red for example, which is different from the color of link character strings for which HTML files corresponding thereto are not recorded in the cache recording data 132.

In this way, the user may recognize that the corresponding HTML file exists in the cache recording data 132 only by moving the cursor 54 onto the link character string. The link character strings “Date-and-Time_{—}2” and “Date-and-Time_{—}4” which are displayed in the option window 55 may be displayed in red, for example.

When an operation of moving a cursor 56 onto the link character string “Date-and-Time_{—}4” included in the option window 55 in the browser screen 152 is performed, the HTML file 135 corresponding to “Date-and-Time_{—}4” is read from the cache recording data 132. Thereafter, content (“Incident_{—}2”, for example) of “Topic_{—}1” corresponding to “Date-and-Time_{—}4” is displayed in a browser screen 153. For example, cache data corresponding to “Topic_{—}1” is displayed in the browser screen 153, and “Incident_{—}2” updated in “Mar. 14, 2011” may be displayed as content of “Topic_{—}1”. A similar operation is performed when the user selects the link character string “Date-and-Time_{—}2” in the browser screen 152, and content (“Incident_{—}1”, for example) of “Topic_{—}1” corresponding to “Date-and-Time_{—}2” is displayed in the browser screen 153.

In the browser screen 152, when the user does not select any of the link character strings “Date-and-Time_{—}2” and “Date-and-Time_{—}4” but selects the link character string “Topic_{—}1”, the communication terminal apparatus 101 obtains content in a link destination of “Topic_{—}1” from a web server through the Internet. Furthermore, even when the user selects a link character string for which an HTML file corresponding thereto does not exist in the cache recording data 132, the communication terminal apparatus 101 obtains content of a link destination specified by a URL associated with the link character string from the web server.

Cache History Process

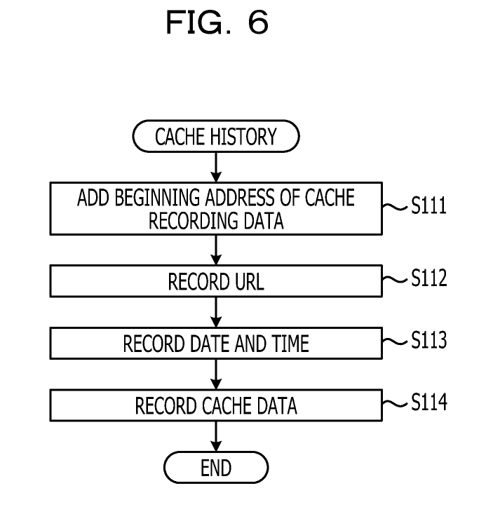

When the browser function performs download, the cache history process is executed. FIG. 6 is a flowchart illustrating the cache history process performed by the communication terminal apparatus 101 according to the second embodiment. As illustrated in FIG. 6, the cache history unit 122 is called by the cache recording unit 121 to add, to the cache history list 131, a beginning address of a storage region in the cache recording data 132. The storage region is for an HTML file to be newly added to the cache recording data 132 (S111).

Next, the cache history unit 122 records, in the cache recording data 132, URL information (cache URL) of the HTML file downloaded by the browser function (S112). Subsequently, the cache history unit 122 records, in the cache recording data 132, date-and-time information (cache date and time) of the HTML file downloaded by the browser function (S113). The date-and-time information (cache date and time) may represent a time point at which the HTML file downloaded by the browser function is recorded in the cache recording data 132, for example.

Thereafter, the cache history unit 122 records, in the cache recording data 132, the HTML file downloaded by the browser function, the URL information (cache URL), and the date-and-time information (cache date and time) of the HTML file as cache data in one file (S114), and the process is terminated.

Cache Display Process

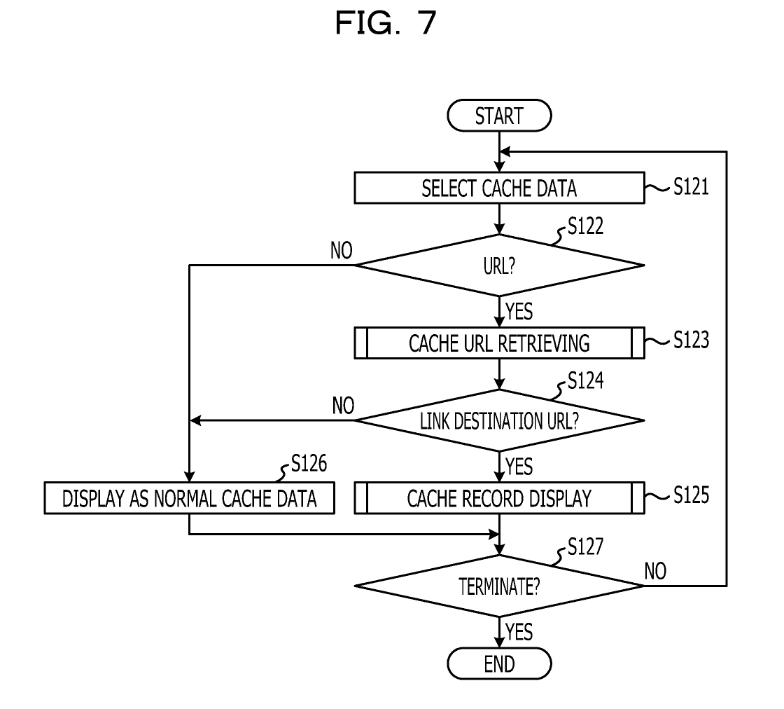

FIG. 7 is a flowchart illustrating the cache display process performed by the communication terminal apparatus 101 according to the second embodiment. As illustrated in FIG. 7, when the user performs an operation of displaying a browser screen in the display unit 3 and displaying cache data recorded by the cache function, the cache display unit 123 is activated. When the user specifies cache data to be displayed from a list of cache data recorded in the cache recording data 132, the cache display unit 123 selects the cache data to be displayed in the display unit 3 in accordance with the user's operation (S121).

Next, the cache display unit 123 determines whether a URL is included in the selected cache data (S122). When a URL is included in the cache data (S122: Yes), the cache display unit 123 calls the cache URL retrieving unit 124. The cache URL retrieving unit 124 executes the cache URL retrieving process which will be described later (S123).

The cache display unit 123 determines whether at least one URL is temporarily stored as a link destination URL obtained as a result of the cache URL retrieving process performed by the cache URL retrieving unit 124 (S124). When at least one URL is temporarily stored as a link destination URL (S124: Yes), the cache display unit 123 calls the cache record display unit 125. The cache record display unit 125 executes the cache record display process which will be described later (S125).

On the other hand, when no URL is included in the cache data selected in S121 (S122: No), the cache display unit 123 displays the cache data selected in S121 in the display unit 3 as normal cache data (S126). Similarly, when no URL is temporarily stored as a link destination URL as a result of the cache URL retrieving process (S124: No), the cache display unit 123 displays the cache data in the display unit 3 as normal cache data (S126).

After displaying the cache data, the cache display unit 123 determines whether the process of displaying cache data is to be terminated (S127). When the process is not to be terminated (S127: No), the process returns to S121 and the cache display unit 123 performs the process from S121 again. When the process is to be terminated (S127: Yes), the cache display unit 123 terminates the entire cache display process.

Cache URL Retrieving Process

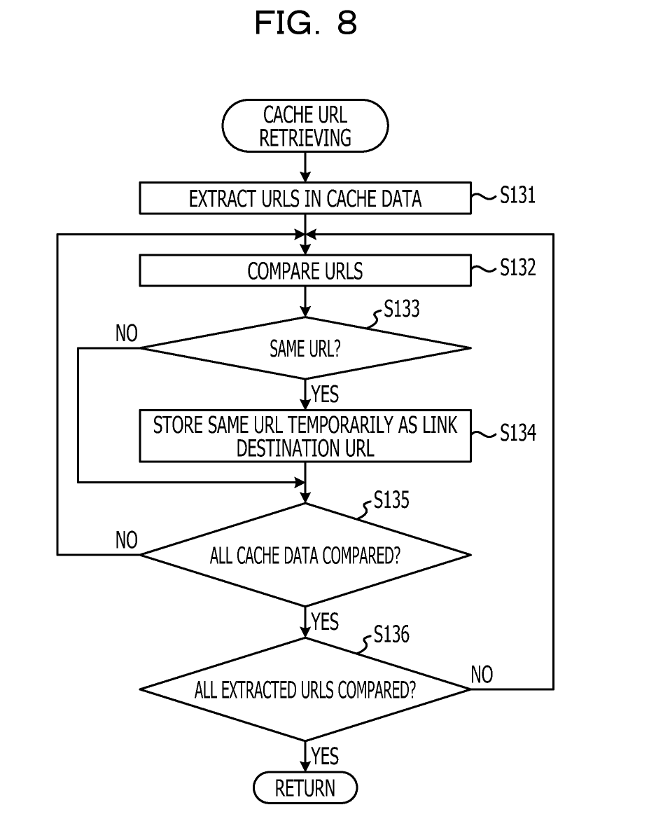

FIG. 8 is a flowchart illustrating the cache URL retrieving process performed by the communication terminal apparatus 101 according to the second embodiment. As illustrated in FIG. 8, the cache URL retrieving unit 124 called by the cache display unit 123 extracts URLs included in cache data selected in the cache display process, that is, cache data displayed in the display unit 3 (S131). Subsequently, the cache URL retrieving unit 124 compares one of the extracted URLs with URLs of cache data recorded in the cache recording data 132 (S132).

Thereafter, the cache URL retrieving unit 124 determines whether the URLs of the cache data recorded in the cache recording data 132 includes the same URL as the extracted URL (S133). When the same URL is included in the URLs of the cache data recorded in the cache recording data 132 (S133: Yes), the cache URL retrieving unit 124 temporarily stores the extracted URL as a link destination URL (S134). In this way, a URL corresponding to a plurality of cache data recorded in the cache recording data 132 is temporarily stored as a link destination URL. When the extracted URL is not included in the URLs of the cache data recorded in the cache recording data 132 (S133: No), the cache URL retrieving unit 124 does not perform any operation.

Thereafter, the cache URL retrieving unit 124 determines whether the comparison between the extracted URL with the URLs of all the cache data recorded in the cache recording data 132 is completed (S135). When the comparison is not completed (S135: No), the process returns to S132 and the cache URL retrieving unit 124 performs the process from S132 again.

When the comparison is completed (S135: Yes), the cache URL retrieving unit 124 determines whether all the URLs extracted from the cache data selected in the cache display process have been subjected to the comparison (S136). When at least one of the URLs extracted from the cache data selected in the cache display process has not been subjected to the comparison (S136: No), the process returns to S132 and the cache URL retrieving unit 124 performs the process from S132 again on another one of the extracted URLs. When all the URLs extracted from the cache data selected in the cache display process have been subjected to the comparison (S136: Yes), the cache URL retrieving unit 124 terminates the entire cache URL retrieving process.

Cache Record Display Process

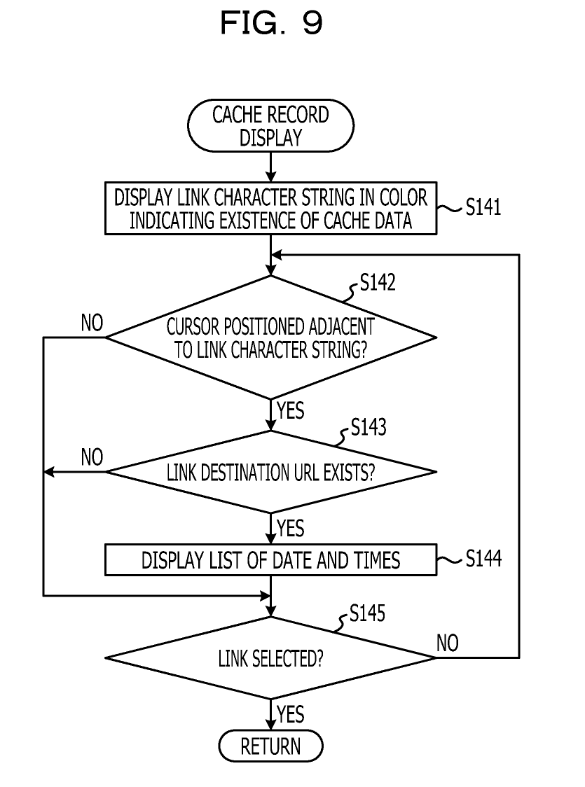

FIG. 9 is a flowchart illustrating the cache record display process performed by the communication terminal apparatus 101 according to the second embodiment. As illustrated in FIG. 9, the cache record display unit 125 called by the cache display unit 123 displays a link character string of cache data to be displayed in the display unit 3 in a color, red for example, indicating that an HTML file corresponding thereto exists in the cache recording data 132 (S141).

Then the cache record display unit 125 determines whether a cursor is positioned adjacent to the link character string (S142). When the cursor is positioned adjacent to the link character string (S142: Yes), the cache record display unit 125 determines whether a URL corresponding to the link character string positioned adjacent to the cursor exists as a link destination URL (S143).

When the URL corresponding to the link character string positioned adjacent to the cursor exists as a link destination URL (S143: Yes), the cache record display unit 125 reads a date and time (cache date and time) of an HTML file corresponding to the URL from the cache recording data 132 and displays the date and time in the display unit 3. When a plurality of HTML files correspond to the URL, the cache record display unit 125 displays a list of date and times (cache date and times) (S144). The cache record display unit 125 may display the date and time (cache date and time) or the list of the date and times in the vicinity of the link character string positioned adjacent to the cursor, for example, on the left side of the link character string.

On the other hand, when the cursor is not positioned adjacent to the link character string (S142: No) or when no link destination URL exists (S143: No), the cache record display unit 125 does not display the date and time or the list of the date and times. Then the cache record display unit 125 determines whether one of the link character string positioned adjacent to the cursor and the additionally displayed link character strings of the cache date and times is selected (S145).

When the selection is made (S145: Yes), the cache record display unit 125 terminates the entire cache record display process, returns to the process in the flowchart illustrated in FIG. 7, selects cache data corresponding to selected date and time from the cache recording data 132, and displays the selected cache data. When the selection is not made (S145: No), the process returns to S142 and the cache record display unit 125 performs the process from S142 again.

According to the second embodiment, as with the first embodiment, in an electronic computer such as a personal computer, when a plurality of target HTML files which are obtained from the same source are stored in the storage unit 2, the option window 55 is displayed in the display unit 3. Accordingly, the user may select an arbitrary one of the target HTML files from options displayed in the option window 55 so that the selected target HTML file is displayed in the display unit 3.

### Third Embodiment

A communication terminal apparatus has a function of storing a screen displayed in a display unit as a memo. Such a function is referred to as a screen memo function, for example. The screen memo function is realized as an application in a communication terminal apparatus such as a cellular phone. In a third embodiment, the communication terminal apparatus according to the first embodiment is applied to a cellular phone or a smart phone which has the screen memo function. In the third embodiment, a case where a URL is used as the identification information will be described as an example.

Hardware Configuration of Communication Terminal Apparatus

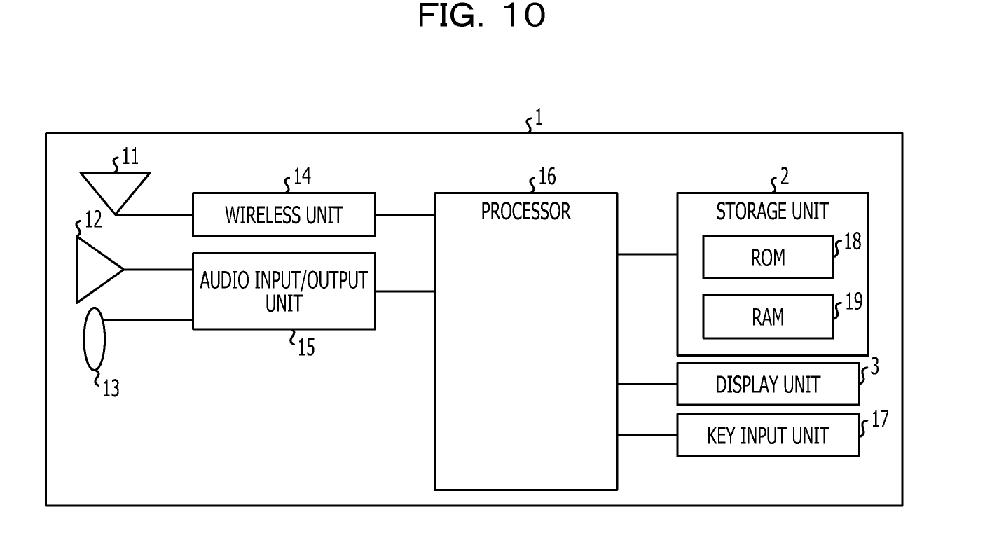

FIG. 10 is a block diagram illustrating a hardware configuration of a communication terminal apparatus according to the third embodiment. As illustrated in FIG. 10, a communication terminal apparatus 1 includes an antenna 11, a speaker 12, a microphone 13, a wireless unit 14, an audio input/output unit 15, a processor 16, a storage unit 2, a display unit 3, and a key input unit 17. The processor 16 is an example of a controller.

The processor 16 executes a screen memo recording process, a screen memo history process, a screen memo display process, a screen memo URL retrieving process, and a screen memo record display process. The processor 16 executes a browser function. The screen memo history process, the screen memo display process, the screen memo URL retrieving process, and the screen memo record display process will be described later.

The antenna 11 is connected to the wireless unit 14. The wireless unit 14 is connected to the processor 16 and performs a transmission process and a reception process. The storage unit 2 is connected to the processor 16 and includes a ROM 18 and a RAM 19. The ROM 18 is merely an example a memory and is replaceable by a rewritable nonvolatile memory such as a flash memory.

The storage unit 2 stores programs for causing the processor 16 to execute the screen memo history process, the screen memo display process, the screen memo URL retrieving process, the screen memo record display process, and the browser function. The storage unit 2 stores the HTML file 5 described in the first embodiment, for example. The storage unit 2 further stores URL information, for example, as an example of the identification information 6. The RAM 19 is used as a work area of the processor 16. Note that it is not necessarily the case that these programs are stored in the storage unit 2 but these programs may be stored in a recording medium such as a CD-ROM and read and executed by the communication terminal apparatus 1. Furthermore, these programs may be stored in another computer (or a server) or the like connected to the communication terminal apparatus 1 through a public line, the Internet, a LAN, a WAN, or the like. In this case, the communication terminal apparatus 1 reads the programs from the computer or the like so as to execute the programs.

The speaker 12 and the microphone 13 are connected to the audio input/output unit 15. The audio input/output unit 15 is connected to the processor 16 and performs processes associated with output and input of audio. The display unit 3 is connected to the processor 16 and displays results of processes performed by the processor 16. The key input unit 17 is connected to the processor 116 and accepts a key input performed by a user.

Functional Configuration of Communication Terminal Apparatus

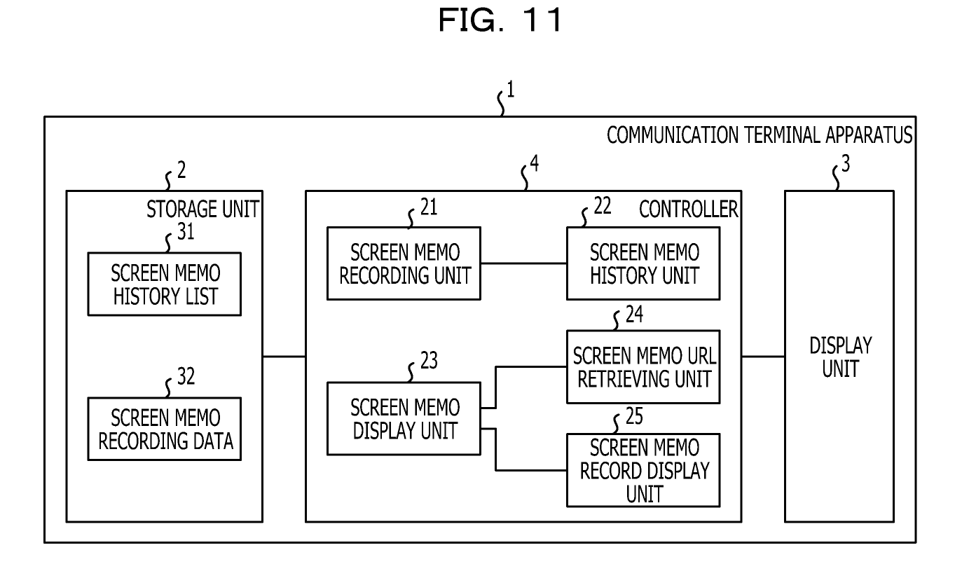

FIG. 11 is a block diagram illustrating a functional configuration of the communication terminal apparatus 1 according to the third embodiment. As illustrated in FIG. 11, the controller 4 of the communication terminal apparatus 1 realizes a screen memo recording unit 21, a screen memo history unit 22, a screen memo display unit 23, a screen memo URL retrieving unit 24, and a screen memo record display unit 25 by executing various programs stored in the storage unit 2.

The screen memo recording unit 21 executes the screen memo recording process. By executing the screen memo recording process, HTML data of a screen memo is recorded in the storage unit 2. The screen memo history unit 22 is called by the screen memo recording unit 21 to execute the screen memo history process which will be described later. As a result of the execution of the screen memo history process, a screen memo history list 31 and screen memo recording data 32, which is an example of the HTML file 5, are stored in the storage unit 2.

The screen memo display unit 23 executes the screen memo display process which will be described later. The screen memo URL retrieving unit 24 is called by the screen memo display unit 23 to execute the screen memo URL retrieving process which will be described later. The screen memo record display unit 25 is called by the screen memo display unit 23 to execute the screen memo record display process which will be described later.

Screen Memo Function

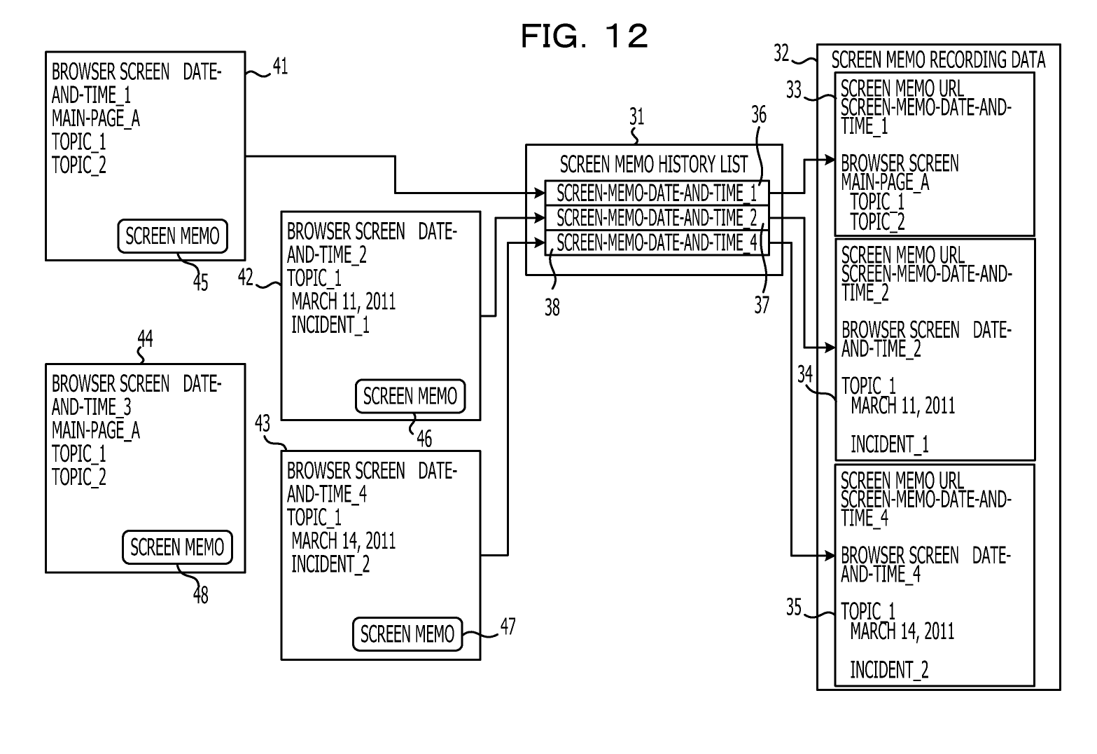

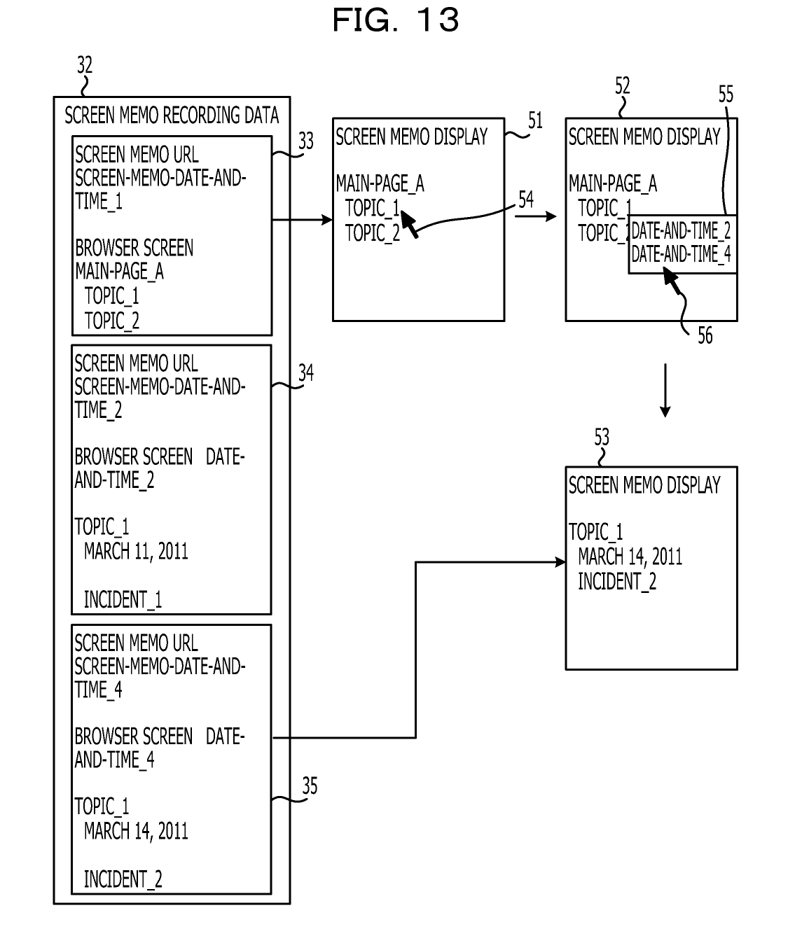

FIGS. 12 and 13 are diagrams schematically illustrating screen memo functions of the communication terminal apparatus 1 according to the third embodiment. FIG. 12 illustrates a function, among the screen memo functions, of recording a screen memo. The function of recording a screen memo is realized by the screen memo recording unit 21 and the screen memo history unit 22 of the controller 4.

As illustrated in FIG. 12, in the communication terminal apparatus 1, browser screens 41 to 44 are displayed in the display unit 3. Display content of the browser screens 41 to 44 is the same as that of the browser screens 141 to 144 of the second embodiment illustrated in FIG. 4, and therefore, descriptions thereof are omitted. In the third embodiment, the browser screens 41 to 44 display “Screen Memo” buttons 45 to 48, respectively, which accept a user's input.

When the display unit 3 is a touch panel and a user touches one of the “Screen Memo” buttons 45 to 48 displayed in the browser screens 41 to 44, respectively, HTML data of content displayed in a corresponding one of the browser screens 41 to 44 is recorded in the screen memo recording data 32. Although not particularly limited, it is assumed that HTML data of the content displayed in the browser screens 41 to 43 is recorded in the screen memo recording data 32 in this embodiment.

The HTML data of the content is recorded as an individual HTML file 33, 34, or 35 in associated with URL information (screen memo URL) of the HTML data and date and time information (screen memo date and times) of a time point at which the HTML data is recorded in the screen memo recording data 32 by pressing one of the “Screen Memo” buttons 45 to 48 by the user. For example, in the HTML file 33 corresponding to the browser screen 41, HTML data of “Screen Memo URL” and HTML data of “Screen-Memo-Date-and-Time_{—}1” which correspond to the browser screen 41, HTML data representing “Browser Screen”, HTML data representing “Main-Page_A”, HTML data representing a link character string “Topic_{—}1”, and HTML data representing a link character string “Topic_{—}2” may be recorded in the screen memo recording data 32.

For example, in the HTML file 34 corresponding to the browser screen 42, HTML data of “Screen Memo URL” and HTML data of “Screen-Memo-Date-and-Time_{—}2” which correspond to the browser screen 42, HTML data representing “Date-and-Time_{—}2”, HTML data representing “Browser Screen”, HTML data representing “Topic_{—}1”, and HTML data representing “Incident_{—}1” updated in “Mar. 11, 2011” may be recorded in the screen memo recording data 32. For example, in the HTML file 35 corresponding to the browser screen 43, HTML data of “Screen Memo URL” and HTML data of “Screen-Memo-Date-and-Time_{—}4” which correspond to the browser screen 43, HTML data representing “Date-and-Time_{—}4”, HTML data representing “Browser Screen”, HTML data representing “Topic_{—}1”, and HTML data representing “Incident_{—}2” updated in “Mar. 14, 2011” may be recorded in the screen memo recording data 3.

Furthermore, beginning addresses 36 to 38 of the HTML files 33 to 35 recorded in the screen memo recording data 32 are added to the screen memo history list 31. In the screen memo history list 31, “Screen-Memo-Date-and-Time_{—}1” represents that the beginning address of the HTML file 33 corresponding to the browser screen 41 displayed at a time point of “Date-and-Time_{—}1” is stored in the screen memo history list 31. “Screen-Memo-Date-and-Time_{—}2” and “Screen-Memo-Date-and-Time_{—}4” represent similar things.

As described in the second embodiment, content of “Topic_{—}1” may be varied depending on a date and time such that content of “Topic_{—}1” corresponding to “Date-and-Time_{—}2” may be “Incident_{—}1” and content of “Topic_{—}1” corresponding to “Date-and-Time_{—}4” may be “Incident_{—}2”.

FIG. 13 illustrates a function, among the screen memo functions, of displaying a screen memo. The function of displaying a screen memo is realized by the screen memo display unit 23, the screen memo URL retrieving unit 24, and the screen memo record display unit 25 of the controller 4. It is assumed that the HTML files 33 to 35 are recorded in the screen memo recording data 32 in advance by the user.

It is further assumed that, as illustrated in FIG. 13, a browser screen 51 is displayed in the display unit 3 of the communication terminal apparatus 1 and a screen of “Main-Page_A” is displayed in the browser screen 51 using the screen memo function in accordance with a user's instruction. “Screen Memo Display” represents that a recorded screen memo is being displayed. In this case, link character strings “Topic_{—}1” and “Topic_{—}2” may be displayed in the browser screen 51. Thereafter, when the user causes a cursor 54 displayed in the browser screen 51 to move onto the link character string “Topic_{—}1”, an option window 55 used to select one of the HTML file 34 corresponding to “Date-and-Time_{—}2” and the HTML file 35 corresponding to “Date-and-Time_{—}4” is displayed in a browser screen 52.

In the option window 55, “Date-and-Time_{—}2” and “Date-and-Time_{—}4” representing date and times at which the HTML files are recorded in the screen memo recording data 32 may be displayed as link character strings. The option window 55 may be displayed close to the link character string “Topic_{—}1”, for example. When a corresponding HTML file is recorded in the screen memo recording data 32 as in the case of “Topic_{—}1”, the link character string “Topic_{—}1” may be displayed in a certain color, red for example, which is different from the color of link character strings for which HTML files corresponding thereto are not recorded in the screen memo recording data 32.

In this way, the user may recognize that the corresponding HTML file exists in the screen memo recording data 32 only by moving the cursor 54 onto the link character string. The link character strings “Date-and-Time_{—}2” and “Date-and-Time_{—}4” which are displayed in the option window 55 may be displayed in red, for example.

When an operation of moving a cursor 56 onto the link character string “Date-and-Time_{—}4” included in the option window 55 in the browser screen 52 is performed, the HTML file 35 corresponding to “Date-and-Time_{—}4” is read from the screen memo recording data 32. Thereafter, content (“Incident_{—}2”, for example) of “Topic_{—}1” corresponding to “Date-and-Time_{—}4” is displayed in a browser screen 53. For example, a screen memo corresponding to “Topic_{—}1” is displayed in the browser screen 53, and “Incident_{—}2” updated in “Mar. 14, 2011” may be displayed as content of “Topic_{—}1”. A similar operation is performed when the user selects the link character string “Date-and-Time_{—}2” in the browser screen 52, and content (“Incident_{—}1”, for example) of “Topic_{—}1” corresponding to “Date-and-Time_{—}2” is displayed in the browser screen 53.

In the browser screen 52, when the user does not select any of the link character strings “Date-and-Time_{—}2” and “Date-and-Time_{—}4” but selects the link character string “Topic_{—}1”, the communication terminal apparatus 1 obtains content in a link destination of “Topic_{—}1” from a web server through the Internet. Furthermore, even when the user selects a link character string for which an HTML file corresponding thereto has not exist in the screen memo recording data 32, the communication terminal apparatus 1 obtains content of a link destination specified by a URL associated with the link character string from the web server.

Screen Memo History Process

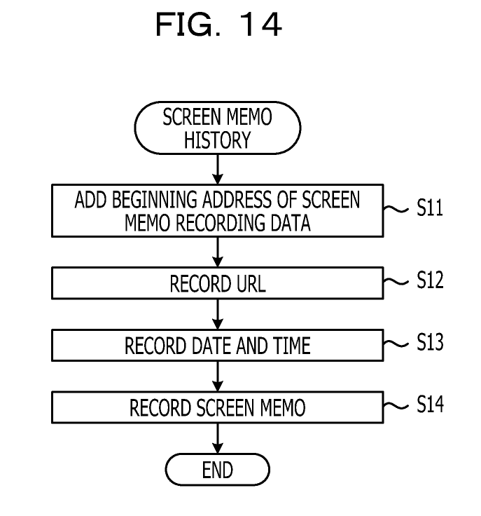

When the user touches a “Screen Memo” button on a browser screen displayed in the display unit 3 of the communication terminal apparatus 1, the screen memo history process is executed. FIG. 14 is a flowchart illustrating the screen memo history process performed by the communication terminal apparatus 1 according to the third embodiment. As illustrated in FIG. 14, the screen memo history unit 22 is called by the screen memo recording unit 21 to add, to the screen memo history list 31, a beginning address of a storage region in the screen memo recording data 32. The storage region is for an HTML file to be newly added to the screen memo recording data 32 (S11).

Next, the screen memo history unit 22 records, in the screen memo recording data 32, URL information (screen memo URL) of the HTML file currently displayed in the browser screen 52 (S12). Next, the screen memo history unit 22 records, in the screen memo recording data 32, date and time information (screen memo date and time) of the HTML file currently displayed in the browser screen 52 (S13). The date-and-time information (screen memo date and time) may represent a time point at which the HTML file currently displayed in the browser screen 52 is recorded in the screen memo recording data 32, for example.

Thereafter, the screen memo history unit 22 records, in the screen memo recording data 32, the HTML file currently displayed in the browser screen 52, the URL information (screen memo URL), and the date-and-time information (screen memo date and time) of the HTML file as a screen memo in one file (S14), and the process is terminated.

Screen Memo Display Process

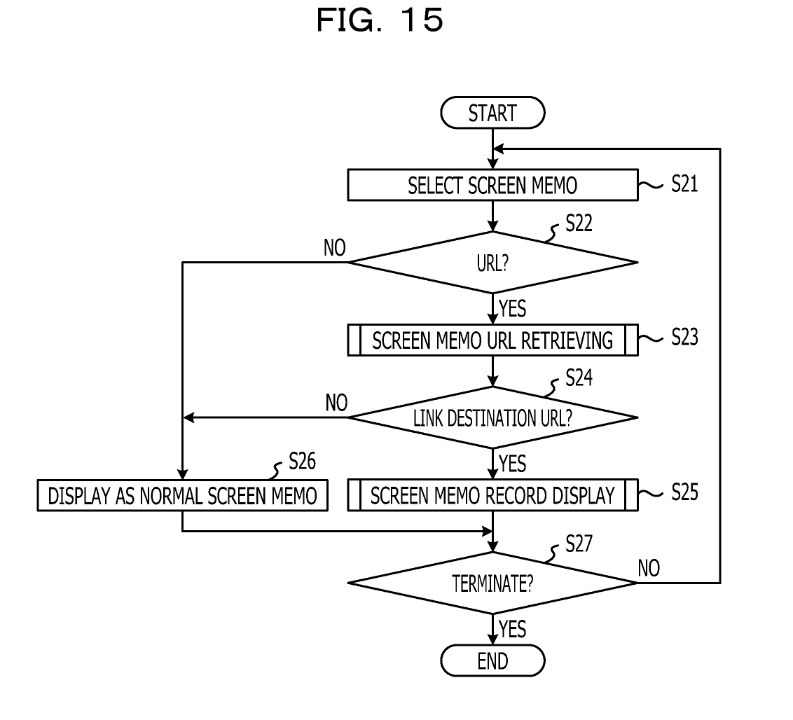

FIG. 15 is a flowchart illustrating the screen memo display process performed by the communication terminal apparatus 1 according to the third embodiment. As illustrated in FIG. 15, when the user performs an operation of displaying a browser screen in the display unit 3 and displaying a recorded screen memo, the screen memo display unit 23 is activated. When the user specifies a screen memo to be displayed from a list of screen memos recorded in the screen memo recording data 32, the screen memo display unit 23 selects the screen memo to be displayed in the display unit 3 in accordance with the user's operation (S21).

Next, the screen memo display unit 23 determines whether a URL is included in data of the selected screen memo (S22). When a URL is included in the screen memo data (S22: Yes), the screen memo display unit 23 calls the screen memo URL retrieving unit 24. The screen memo URL retrieving unit 24 executes the screen memo URL retrieving process which will be described later (S23).

The screen memo display unit 23 determines whether at least one URL is temporarily stored as a link destination URL obtained as a result of the screen memo URL retrieving process performed by the screen memo URL retrieving unit 24 (S24). When at least one URL is temporarily stored as a link destination URL (S24: Yes), the screen memo display unit 23 calls the screen memo record display unit 25. The screen memo record display unit 25 executes the screen memo record display process which will be described later (S25).

On the other hand, when no URL is included in the data of the screen memo selected in S21 (S22: No), the screen memo display unit 23 displays the screen memo selected in S21 in the display unit 3 as a normal screen memo (S26). Similarly, when no URL is temporarily stored as a link destination URL as a result of execution of the screen memo URL retrieving process (S24: No), the screen memo display unit 23 displays the screen memo in the display unit 3 as a normal screen memo (S26).

After displaying the screen memo, the screen memo display unit 23 determines whether the process of displaying a screen memo is to be terminated (S27). When the process is not to be terminated (S27: No), the process returns to S21 and the screen memo display unit 23 performs the process from S21 again. When the process is to be terminated (S27: Yes), the screen memo display unit 23 terminates the entire screen memo display process.

Screen Memo URL Retrieving Process

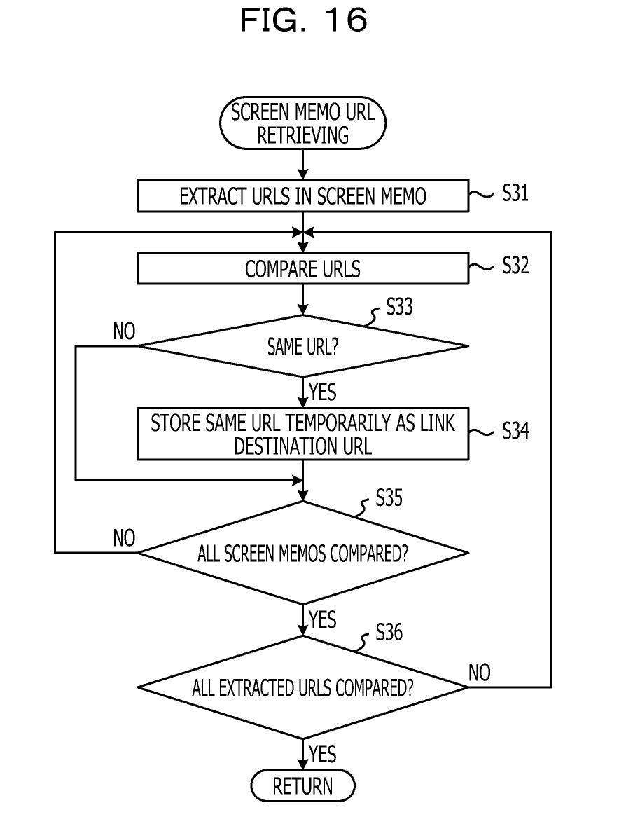

FIG. 16 is a flowchart illustrating the screen memo URL retrieving process performed by the communication terminal apparatus according to the third embodiment. As illustrated in FIG. 16, the screen memo URL retrieving unit 24 called by the screen memo display unit 23 to extract URLs included in a screen memo selected in the screen memo display process, that is, a screen memo displayed in the display unit 3 (S31). Subsequently, the screen memo URL retrieving unit 24 compares one of the extracted URLs with URLs of screen memos recorded in the screen memo recording data 32 (S32).

Thereafter, the screen memo URL retrieving unit 24 determines whether the URLs of the screen memos recorded in the screen memo recording data 32 includes the same URL as the extracted URL (S33). When the same URL is included in the URLs of the screen memos recorded in the screen memo recording data 32 (S33: Yes), the screen memo URL retrieving unit 24 temporarily stores the extracted URL as a link destination URL (S34). In this way, a URL corresponding to a plurality of screen memos recorded in the screen memo recording data 32 is temporarily stored as a link destination URL. When the extracted URL is not included in the URLs of the screen memos recorded in the screen memo recording data 32 (S33: No), the screen memo URL retrieving unit 24 does not perform any operation.

Thereafter, the screen memo URL retrieving unit 24 determines whether the comparison between the extracted URL with the URLs of all the screen memos recorded in the screen memo recording data 32 is completed (S35). When the comparison is not completed (S35: No), the process returns to S32 and the screen memo URL retrieving unit 24 performs the process from S32 again.

When the comparison is completed (S35: Yes), the screen memo URL retrieving unit 24 determines whether all the URLs extracted from the screen memos selected in the screen memo display process have been subjected to the comparison (S36). When at least one of the URLs extracted from the screen memos selected in the screen memo display process has not been subjected to the comparison (S36: No), the process returns to S32 and the screen memo URL retrieving unit 24 performs the process from S32 again on another one of the extracted URLs. When all the URLs extracted from the screen memos selected in the screen memo display process have been subjected to the comparison (S36: Yes), the screen memo URL retrieving unit 24 terminates the entire screen memo [0093] URL retrieving process.

Screen Memo Record Display Process

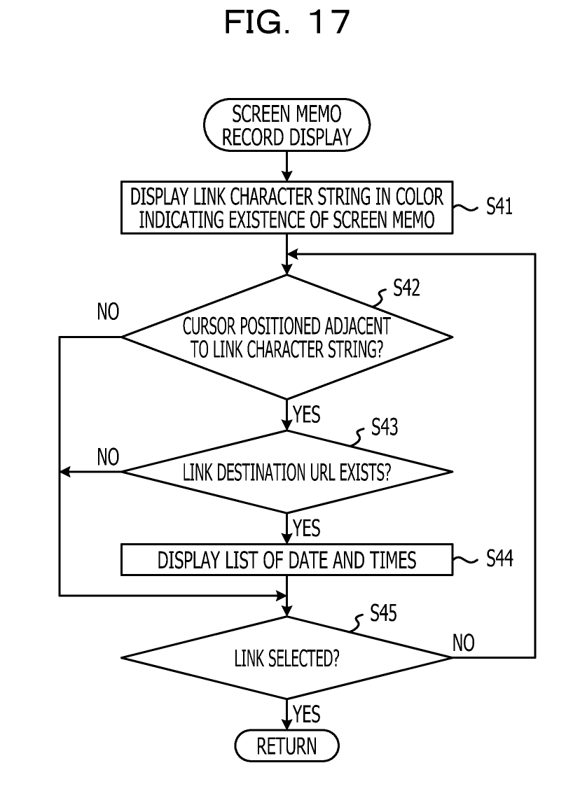

FIG. 17 is a flowchart illustrating the screen memo record display process performed by the communication terminal apparatus 1 according to the third embodiment. As illustrated in FIG. 17, the screen memo record display unit 25 called by the screen memo display unit 23 displays a link character string of a screen memo to be displayed in the display unit 3 in a color, red for example, indicating that an HTML file corresponding thereto exists in the screen memo recording data 32 (S41).

Then the screen memo record display unit 25 determines whether a cursor is positioned adjacent to the link character string (S42). When the cursor is positioned adjacent to the link character string (S42: Yes), the screen memo record display unit 25 determines whether a URL corresponding to the link character string positioned adjacent to the cursor exists as a link destination URL (S43).

When the URL corresponding to the link character string positioned adjacent to the cursor exists as a link destination URL (S43: Yes), the screen memo record display unit 25 reads a date and time (screen memo date and time) of an HTML file corresponding to the URL from the screen memo recording data 32 and displays the date and time in the display unit 3. When a plurality of HTML files correspond to the URL, the screen memo record display unit 25 displays a list of date and times (screen memo date and times) (S44). The screen memo record display unit 25 may display the date and time (screen memo date and time) or the list of the date and times in the vicinity of the link character string positioned adjacent to the cursor, for example, on the left side of the link character string.

On the other hand, when the cursor is not positioned adjacent to the link character string (S42: No) or when no link destination URL exists (S43: No), the screen memo record display unit 25 does not display the date and time or the list of the date and times. Then the screen memo record display unit 25 determines whether one of the link character string positioned adjacent to the cursor and the link character strings of the screen memo date and times is selected (S45).

When the selection is made (S45: Yes), the screen memo record display unit 25 terminates the entire screen memo record display process, returns to the process in the flowchart illustrated in FIG. 15, selects a screen memo corresponding to the selected date and time from the screen memo recording data 32, and displays the selected screen memo. When the selection is not made (S45: No), the process returns to S42 and the screen memo record display unit 25 performs the process from S42 again.

According to the third embodiment, as with the first embodiment, in a cellular phone or a smart phone, when a plurality of target HTML files which are obtained from the same source are stored in the storage unit 2, the option window 55 is displayed in the display unit 3. Accordingly, the user may select an arbitrary one of the target HTML files from the options displayed in the option window 55 so that the selected target HTML file is displayed in the display unit 3.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication terminal apparatus comprising:
a storage unit to store an obtained file and identification information in association with each other, the identification information identifying a source of the obtained file; and
a processor to
display, in a display unit, a screen including a link character string associated with the identification information, and
display in the display unit, when a plurality of target files exist in the storage unit, options used to select one of the plurality of target files, each of the plurality of target files being associated with the identification information which is associated with the link character string included in the screen.

2. The communication terminal apparatus according to claim 1, wherein
the processor displays the options in the display unit when the link character string included in the screen is specified.

3. The communication terminal apparatus according to claim 1, wherein
the storage unit stores date and time information in association with the obtained file, the date and time information being information regarding a time point at which the obtained file is obtained, and
the options represent information based on the date and time information associated with the obtained file.

4. A computer-readable recording medium storing a program that causes a computer to execute a procedure, the computer including a storage unit which stores an obtained file and identification information in association with each other, the identification information identifying a source of the obtained file, the procedure comprising:
displaying, in a display unit, a screen including a link character string associated with the identification information; and
displaying in the display unit, when a plurality of target files exist in the storage unit, options used to select one of the plurality of target files, each of the plurality of target files being associated with the identification information which is associated with the link character string included in the screen.
